(19) United States
(12) Patent Application Publication
(10) Pub. No.: US 2026/0129514 A1
(43) Pub. Date: May 7, 2026

(54) TRANSMISSION WINDOW OR RECEPTION WINDOW FOR WIRELESS COMMUNICATIONS

(71) Applicant: Lenovo (United States) Inc., Morrisville, NC (US)

(72) Inventors: Shwetha Sreejith, Steinbach (DE); Joachim Löhr, Wiesbaden (DE)

(73) Assignee: Lenovo (United States) Inc., Morrisville, NC (US)

(21) Appl. No.: 18/940,555

(22) Filed: Nov. 7, 2024

(51) Int. Cl. H04W 28/06

(52) U.S. Cl. CPC H04W 28/065

(57) ABSTRACT

Various aspects of the present disclosure relate to managing (e.g., configuring, determining, establishing, selecting, controlling, and the like) transmission window or reception window for wireless communications. One or more of a network equipment (NE) (e.g., a base station) or a user equipment (UE) may be configured to, capable of, or operable to transmit a first signaling that indicates a transmitter-based (Tx-based) report associated with radio link control (RLC) of the NE or the UE based at least in part on one or more triggers, one or more conditions, or a combination thereof. One or more of the NE or the UE may be configured to, capable of, or operable to receive a second signaling that indicates a receiver-based (Rx-based) report associated with the RLC of the NE or the UE and, based at least in part on the received Rx-based report, update a transmission window.

### TECHNICAL FIELD

The present disclosure relates to wireless communications, and more specifically to managing (e.g., configuring, determining, establishing, selecting, controlling, and the like) transmission window or reception window for wireless communications.

### BACKGROUND

A wireless communications system may include one or multiple network communication devices, which may be otherwise knowns as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

An apparatus for wireless communication is described. The apparatus may be one or more of a NE (e.g., a base station) or a UE. The apparatus may be configured to, capable of, or operable to perform one or more operations as described herein. For example, the apparatus may be configured to, capable of, or operable to transmit a first signaling that indicates a transmitter-based (Tx-based) report associated with radio link control (RLC) of the apparatus based at least in part on one or more triggers, one or more conditions, or a combination thereof; receive a second signaling that indicates a receiver-based (Rx-based) report associated with the RLC of the apparatus; and update, based at least in part on the received Rx-based report, a transmission window of the apparatus.

A processor for wireless communication is described. The processor may be included in (e.g., be a component of) one or more of a NE (e.g., a base station) or a UE. The processor may be configured to, capable of, or operable to perform one or more operations as described herein. For example, the processor may be configured to, capable of, or operable to transmit a first signaling that indicates a Tx-based report associated with RLC of an apparatus based at least in part on one or more triggers, one or more conditions, or a combination thereof; receive a second signaling that indicates a Rx-based report associated with the RLC of the apparatus; and update, based at least in part on the received Rx-based report, a transmission window of the apparatus.

A method performed or performable by an apparatus for wireless communication is described. The apparatus may be one or more of a NE (e.g., a base station) or a UE. The method performed or performable may include transmitting a first signaling that indicates a Tx-based report associated with RLC of an apparatus based at least in part on one or more triggers, one or more conditions, or a combination thereof; receiving a second signaling that indicates a Rx-based report associated with the RLC of the apparatus; and updating, based at least in part on the received Rx-based report, a transmission window of the apparatus.

In some implementations of the apparatus, processor, and method described herein, the Tx-based report includes information that identifies invalid (e.g., expired, outdated) RLC packet data units (PDUs).

In some implementations of the apparatus, processor, and method described herein, the Tx-based report includes information that identifies valid (e.g., non-outdated, not outdated) RLC PDUs.

Some implementations of the apparatus, processor, and method described herein, the apparatus, processor, and method may further be configured to, capable of, performed, performable, or operable to transmit the first signaling based at least in part on at least a first trigger of the one or more triggers being satisfied, wherein the first trigger comprises a threshold count value of PDUs.

Some implementations of the apparatus, processor, and method described herein, the apparatus, processor, and method may further be configured to, capable of, performed, performable, or operable to transmit the first signaling based at least in part on a count value of invalid (e.g., outdated, delayed) PDUs being greater than or equal to the threshold count value.

Some implementations of the apparatus, processor, and method described herein, the apparatus, processor, and method may further be configured to, capable of, performed, performable, or operable to transmit the first signaling based at least in part on a first trigger of the one or more triggers being satisfied, wherein the first trigger comprises the Rx-based report, and wherein the Rx-based report includes information that identifies abandoned data (e.g., discarded data, dropped data, skipped data).

Some implementations of the apparatus, processor, and method described herein, the apparatus, processor, and method may further be configured to, capable of, performed, performable, or operable to construct at least one PDU based at least in part on one or more PDUs previously indicated as one or more of abandoned and invalid; and transmit a third signaling that includes the at least one constructed PDU.

An apparatus for wireless communication is described. The apparatus may be one or more of a NE (e.g., a base station) or a UE. The apparatus may be configured to, capable of, or operable to perform one or more operations as described herein. For example, the apparatus may be configured to, capable of, or operable to receive a first signaling that indicates a Tx-based report associated with RLC at the apparatus based at least in part on one or more triggers, one or more conditions, or a combination thereof; transmit a second signaling that indicates a Rx-based report associated with the RLC of the apparatus; and update, based at least in part on the transmitted Rx-based report, a reception window of the apparatus.

A processor for wireless communication is described. The processor may be included in (e.g., be a component of) one or more of a NE (e.g., a base station) or a UE. The processor may be configured to, capable of, or operable to perform one or more operations as described herein. For example, the processor may be configured to, capable of, or operable to receive a first signaling that indicates a Tx-based report associated with RLC at an apparatus based at least in part on one or more triggers, one or more conditions, or a combination thereof; transmit a second signaling that indicates a Rx-based report associated with the RLC of the apparatus; and update, based at least in part on the transmitted Rx-based report, a reception window of the apparatus.

A method performed or performable by an apparatus for wireless communication is described. The apparatus may be one or more of a NE (e.g., a base station) or a UE. The method performed or performable may include receiving a first signaling that indicates a Tx-based report associated with RLC at an apparatus based at least in part on one or more triggers, one or more conditions, or a combination thereof; transmitting a second signaling that indicates a Rx-based report associated with the RLC of the apparatus; and updating, based at least in part on the transmitted Rx-based report, a reception window of the apparatus.

In some implementations of the apparatus, processor, and method described herein, the Tx-based report includes information that identifies invalid (e.g., outdated, expired) RLC PDUs.

In some implementations of the apparatus, processor, and method described herein, the Tx-based report includes information that identifies valid (e.g., non-outdated) RLC PDUs.

Some implementations of the apparatus, processor, and method described herein, the apparatus, processor, and method may further be configured to, capable of, performed, performable, or operable to receive a third signaling that includes at least one PDU constructed based at least in part on one or more PDUs previously indicated as one or more of abandoned and valid (e.g., non-outdated).

Some implementations of the apparatus, processor, and method described herein, the apparatus, processor, and method may further be configured to, capable of, performed, performable, or operable to submit (e.g., deliver, forward) the at least one PDU to a higher layer of a protocol stack irrespective of whether the at least one PDU is outside of the reception window, wherein the higher layer is higher than a RLC layer of the protocol stack.

Some implementations of the apparatus, processor, and method described herein, the apparatus, processor, and method may further be configured to, capable of, performed, performable, or operable to receive an additional Tx-based report that indicates one or more RLC sequence numbers (SNs) as invalid that were previously indicated as abandoned; and ignore the additional Tx-based report.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of Packet Data Convergence Protocol (PDCP) and RLC reception.

FIG. 4 illustrates an example of PDCP and RLC reception after expiration of a reordering timer.

FIGS. 5 and 6 illustrate example formats for a Tx-based report in accordance with aspects of the present disclosure.

FIG. 7 illustrates example formats for a Rx-based report in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a NE in accordance with aspects of the present disclosure.

FIGS. 11 and 12 illustrate flowcharts of methods in accordance with aspects of the present disclosure.

### DETAILED DESCRIPTION

A network node (e.g., a NE, a UE, or both) may be configured with one or multiple protocol stacks, such as a control plane (CP)-protocol stack and a user plane (UP)-protocol stack. Each of the CP-protocol stack and the UP-protocol stack may include various protocol layers (also referred to as entities), including one or more of an application (APP) layer, a radio resource control (RRC) layer, a non-access stratum (NAS) layer, a PDCP layer, an RLC layer, a medium access control (MAC) layer, or a physical (PHY) layer. In 3rd Generation Partnership Project (3GPP) 5G New Radio (NR), PDCP and RLC layers of the UP-protocol stack may function independently from each other.

For the network node operable as a receiver entity, a PDCP layer may maintain a reordering window to receive (e.g., obtain) and transmit (e.g., submit, forward) PDCP PDUs to higher layers of a protocol stack. At an RLC layer of the receiver entity, the receiver entity may maintain a reception window to receive (e.g., obtain) and transmit (e.g., submit, forward) RLC PDUs to higher layers of the protocol stack. At the PDCP layer of the receiver entity, the reordering window may be controlled in accordance with a timer (e.g., t-Reordering timer), which may be configured by RRC. When the timer expires, the reordering window may slide (e.g., transition) forward, for example, the lower bound of the reordering window may be updated. If a packet is received outside of the reordering window, the packet may be discarded by the receiver entity at the PDCP layer of the receiver entity.

An RLC layer may be configured with one or more modes, including a transparent mode (TM), an unacknowledged mode (UM), and an acknowledged mode (AM). In the AM mode, the receiver entity may slide (e.g., update, transition) a reception window when a lowest packet in the window (e.g., a packet with a sequence number (SN) that matches a lower bound of an RLC AM reception window) has been completely received and an acknowledgement has been transmitted for the same. Because the PDCP and RLC layers function independently, the reception window and the reordering window may not be updated concurrently (e.g., at the same time). If the PDCP reordering window moves (e.g., slides, transitions) forward while the reception window is not updated, the RLC layer might transmit (e.g., submit, forward) packets to the PDCP layer that are outside of the reordering window leading to discarding (e.g., dropping) of such packets. The transmission of these packets not only wastes resources but also introduces unwanted latency to the UP.

A combined approach to the AM mode can be used to mitigate or decrease unnecessary retransmissions by the RLC layer. The combined approach refers to a network node operable as a transmitter entity (e.g., at a Tx side) stopping (e.g., pausing, terminating) transmissions of an invalid (e.g., outdated, expired) service data unit (SDU). An invalid SDU, in terms of being outdated, may refer to an SDU having an associated timer (e.g., a discardTimer or discardTimerForLowImportance) that has expired or elapsed. Another network node operable as a receiver entity (e.g., at an Rx side) may abandon (e.g., discard, drop, skip) the SDU based at least in part on a timer at the Rx (e.g., a timer started when the SDU is delivered to a higher layer (e.g., higher than the RLC layer) out of sequence). The receiver entity may notify (e.g., inform) the transmitter entity about the abandoned SDUs. In some cases, a current scheduling request (SR) for transmission of the notification can be reused unless issues are identified. The transmitter entity may evaluate various conditions and/or triggers to allow information at the transmitter entity to be communicated to the receiver entity, for example by triggering a Tx-based report that indicates information relating to invalid (e.g., outdated, expired) or valid (e.g., non-outdated) packets or data.

Invalid data (e.g., expired data, outdated data) refers to data that can be discarded (e.g., deleted, dropped, ignored) due to a timer associated with the data having expired or lapsed. For example, an RLC PDU is considered ‘invalid’ due to a discardTimer or discardTimerForLowImportance associated with the PDU having elapsed or expired.

Valid data (e.g., non-expired data, non-outdated data) refers to data that is not to be discarded (e.g., deleted, dropped, ignored) due to a timer associated with the data not having expired or lapsed. For example, an RLC PDU is considered ‘valid’ if a discardTimer or discardTimerForLowImportance associated with the PDU has not elapsed expired.

Abandoned data (e.g., discarded data, dropped data, skipped data) refers to data that the RLC Rx no longer tries to receive if it has not been previously successfully received. For example, data that the RLC Rx has not received and no longer tries to recover (such as by means of retransmission). Data can be considered abandoned, for example, if a timer at the RLC Rx, started when a RLC SDU is delivered to a higher layer (e.g., higher than the RLC layer) out of sequence, elapses or expires.

The PDCP and RLC layers of the transmitter entity may have the latest information with respect to discard timers of packets as well as an association of one or more PDUs to PDU sets. With the combined approach, where the transmission or retransmission of PDUs is stopped (e.g., paused, terminated) based on discard information received from the PDCP layer of the transmitter entity, while the transmission and reception windows are updated based at least in part on the timer at the receiver entity (e.g., at the RLC layer of the receiver entity), inefficiencies can arise during the window updates. For example, an RLC PDU associated with a PDCP Control PDU may be abandoned (e.g., dropped, discarded, skipped) based on an expiry of a timer. By way of another example, the RLC layer of the receiver entity may start (e.g., activate) the timer for each PDU of a PDU set even when pdu-SetDiscard is configured.

Various aspects of the present disclosure provide enhancements to an RLC layer when the combined approach is applied to avoid unnecessary retransmissions. These techniques provide for data transmission and reception that is favorable in terms of resource utilization as well as latency to make the UP functionality efficient for services such as extended reality (XR) that are extremely delay-sensitive. These enhancements include, for example, determining, selecting, identifying, configuring, and/or indicating conditions and/or triggers for the RLC Tx side to enable full information at the RLC Rx side (e.g., by triggering a Tx-based report that indicates information relating to invalid (e.g., outdated, expired) (or valid (e.g., non-outdated)) packets). Configuration for how this report may be formatted as well as some behavioral aspects when a redundant report is received are also discussed herein.

In one or more implementations, a transmitter entity (e.g., an RLC layer of the transmitter entity) may trigger a transmission of a report (e.g., a Tx-based Control PDU) to a receiver entity that includes additional information associated with one or more invalid (e.g., outdated, expired) packets. The trigger may be, for example, based on a PDU count threshold, where if a number of invalid (e.g., outdated, expired) PDUs is greater than (e.g., exceeds) or equal to the count threshold, the transmitter entity (e.g., the RLC layer of the transmitter entity) may trigger transmission of the report. The PDU count threshold may be configured or pre-configured by a network entity (e.g., a base station).

Additionally, or alternatively, the receiver entity (e.g., an RLC layer of the receiver entity) may trigger a transmission of a report (e.g., Rx-based Control PDU), for example, based at least in part on (or in response to) an expiry of a timer. The report may include information of the one or more RLC PDUs, which may be abandoned (e.g., discarded, dropped, skipped) by the receiver entity (e.g., the RLC layer of the receiver entity). The reporting may be achieved by a separate control PDU (i.e., different from a legacy status report) specific to abandoned PDUs. In another example, the report may be a status report that indicates both RLC PDUs that were successfully received as well as those that are abandoned with an additional indication to differentiate between the successfully acknowledged (e.g., ACK received) versus abandoned PDUs.

Additionally, or alternatively, if a Tx-based report is received by the receiver entity (e.g., the RLC layer of the receiver entity) while the timer is running, and the Tx-based report indicates an RLC PDU that started (e.g., triggered, activated, enabled) the timer as invalid (e.g., outdated, expired), the timer may be stopped (e.g., deactivated, disabled), and a reception window can be updated (e.g., adjusted). This may additionally trigger transmitting an Rx-based report to update a transmission window. Furthermore, the receiver entity (e.g., the RLC layer of the receiver entity) may restart the timer as appropriate (e.g., if the reception window is updated to a next RLC SN that has not yet been received in-order).

Aspects of the present disclosure are described in the context of a wireless communications system.

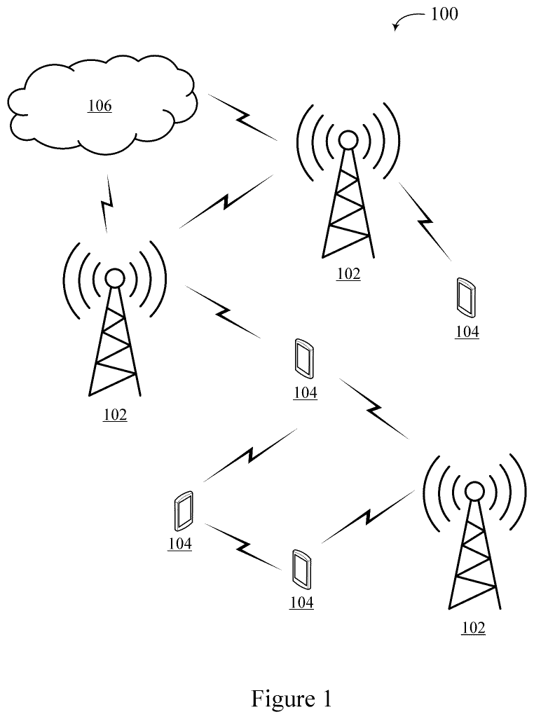

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FRI (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologics). For example, FR2 may be associated with a third numerology (e.g., μ=2), which includes 60 kHz subcarrier spacing; and a fourth numerology (e.g., μ=3), which includes 120 kHz subcarrier spacing.

The UEs 104 and NEs 102 can communicate with one another using a combined approach to the RLC AM to avoid unnecessary RLC retransmissions. Various enhancements to RLC are discussed herein, such as one or more conditions and/or one or more triggers to cause information to be transmitted to the Rx side (e.g., by triggering transmitting to the Rx side a Tx-based report that indicates information relating to invalid (e.g., outdated, expired) (or valid (e.g., non-outdated)) packets).

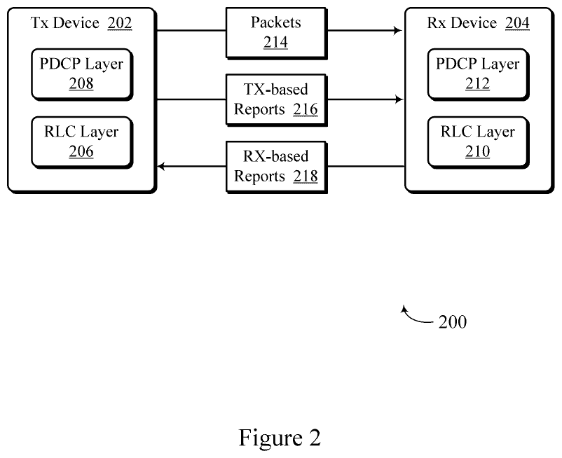

FIG. 2 illustrates an example 200 of wireless communication in accordance with aspects of the present disclosure. The example 200 includes a Tx device 202 and an Rx device 204. Each of the Tx device 202 and the Rx device 204 can be, for example, a UE 104 or an NE 102. The Tx device 202 includes an RLC layer 206 and a PDCP layer 208, and the Rx device 204 includes an RLC layer 210 and a PDCP layer 212. The Tx device 202 transmits packets 214 (e.g., PDUs) to the Rx device 204. The Tx device 202 also transmits Tx-based reports 216 to the Rx device. The Tx-based reports 216 include information with respect to invalid (e.g., outdated, expired) packets that have been transmitted to the Rx device 204. The Rx device 204 transmits Rx-based reports 218 to the Tx device 202. The Rx-based reports 218 include information regarding PDUs that are being abandoned by the Rx device 204.

The RLC layer 206 controls a radio link with the RLC layer 210. Packets 214 (e.g., PDUs) are received at the RLC layer 210 and provided to the PDCP layer 212. The PDCP layer 212 manages received packets 214 (e.g., PDUs), reordering packets that arrive at the Rx device 204 out of order, sequentially delivering packets to higher layers at the Rx device 204, and so forth. The RLC layer 206 and the PDCP layer 208 are two layers in a protocol stack at the Tx device 202. Although not illustrated in the example 200, it is to be appreciated that the protocol stack at the Tx device 202 can include additional layers below the RLC layer 206 and the PDCP layer 208, such as a MAC layer or a PHY layer, and/or additional layers above the RLC layer 206 and the PDCP layer 208, such as an SDAP layer, an RRC layer, and/or an NAS layer. Similarly, although not illustrated in the example 200, it is to be appreciated that the protocol stack at the Rx device 204 can include additional layers below the RLC layer 210 and the PDCP layer 212, such as a MAC layer or a PHY layer, and/or additional layers above the RLC layer 210 and the PDCP layer 212, such as an SDAP layer, an RRC layer, and/or an NAS layer.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

As discussed above, the PDCP layer 212 and the RLC layer 210 function independently, so the reception window and reordering window at the Rx device 204 may not be updated at the same time. If the PDCP reordering window moves forward while the RLC window is not updated, the RLC layer might transmit packets to the PDCP layer that are outside of the reordering window leading to discard of such packets.

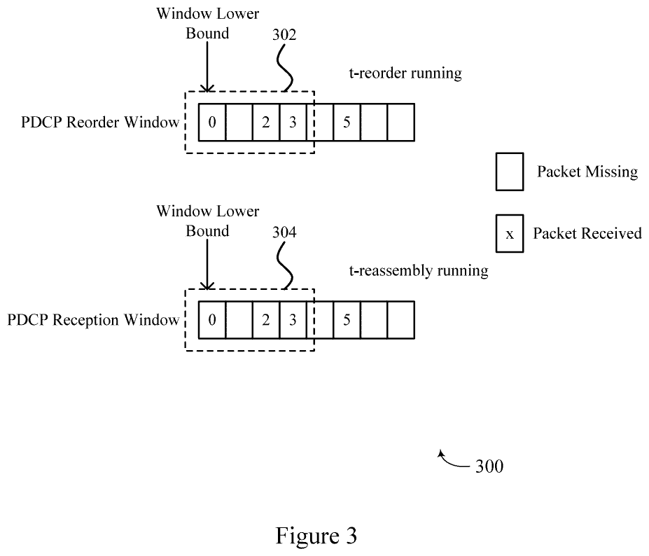

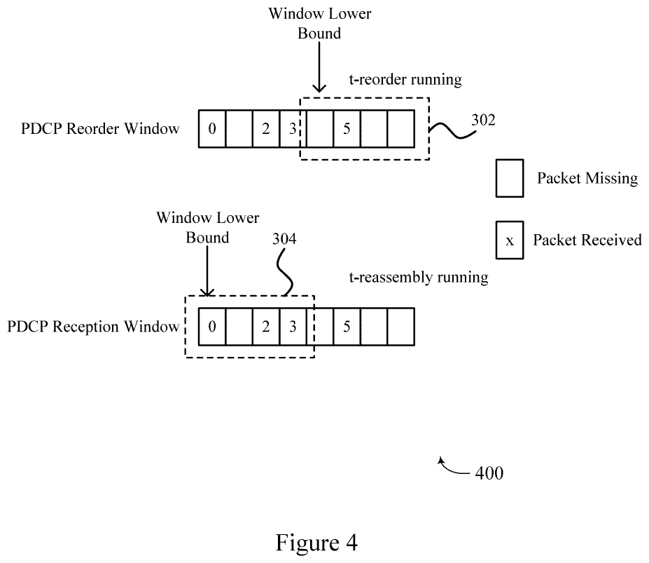

FIG. 3 illustrates an example 300 of PDCP and RLC reception. The example 300, along with the example 400 of FIG. 4 below, illustrates problems with conventional 5G NR. The example 300 shows the reordering window 302 in PDCP and the reception window 304 in RLC AM mode where the lower bounds of both windows are expecting PDU with SN=0 (COUNT=0 in case of PDCP where COUNT=[hyper frame number (HFN), SN]). The RLC receiving entity (e.g., Rx device 204 of FIG. 2) has correctly and fully received packets numbered 0, 2 and 3, and hence transmitted these packets to the PDCP layer (e.g., PDCP layer 212 of FIG. 2). The PDCP layer has also received packets numbered 0, 2 and 3, with a missing packet numbered 1. Hence the receiving entity starts a t-Reordering timer for PDCP when the PDCP layer receives packet 2 before 1. Additionally, the receiving entity starts a t-reassembly timer for RLC since one or more segments of packet 1 are not received yet. When the t-Reordering timer expires, the PDCP reordering window 302 updates its lower bound to the next packet that has not been consecutively received.

FIG. 4 illustrates an example 400 of PDCP and RLC reception after expiration of a reordering timer (e.g., the t-Reordering timer). In the example 400 packet 4 is the next packet that has not been consecutively received after the t-Reordering expired. Hence, the lower bound of the PDCP reordering window 302 is moved to packet 4, whereas in RLC, the t-reassembly only triggers a status report upon expiry and the reception window 304 does not update unless the status report contains an acknowledgement (ACK) for packet 1. Since the RLC receiving entity has not received packet 1, the RLC layer still tries to recover the packet by means of retransmissions or retransmissions. Once the packet is recovered by the RLC layer, the RLC layer transmits the packet to the PDCP layer which will discard the packet as the packet is outside of the reordering window. These redundant transmissions are not only a waste of resources but can also add unwanted latency on the user plane.

Returning to FIG. 2, for enhancements to the RLC AM mode, the combined approach is considered for avoiding unnecessary retransmissions as follows. In conventional 5G NR, the RLC receiving window always advances to any given RLC SN before the transmitting window docs. In the combined approach for avoiding unnecessary RLC retransmissions, the Tx side stops transmissions of an invalid (e.g., outdated, expired) SDU, and the Rx side abandons the SDU based on a local timer. The Rx side informs the Tx side about the abandoned SDUs, as a baseline it is assumed existing SR can be reused unless issues are identified.

The techniques discussed herein address some aspects of using the combined approach to avoid unnecessary retransmissions. Since it is understood that the RLC window updates will be dictated by a new local timer within the RLC receiver, the RLC Rx may not have the entire information with respect to the invalid (e.g., outdated, expired) packets on the Tx side. In one example, where pdu-SetDiscard is configured, the PDCP Tx discards all PDUs associated with a PDU set if the discard timer of at least one PDU of that PDU set expires. While the PDCP layer at the Tx informs this to the RLC layer at the Tx, the RLC Rx is unaware of this consecutive discard and may try to recover for one PDU at a time leading to additional latency on the user plane. In another example, the RLC Rx may be unaware of those RLC SDUs associated with a PDCP Control PDU and may abandon the recovery or reception of such a SDU if the local timer runs out. Hence, some additional enhancements are discussed herein to make the combined approach is a robust solution.

The techniques discussed herein describe some enhancements that can be adopted on RLC when the combined approach is used to avoid unnecessary retransmissions. For example, what conditions and triggers may be configured to the RLC Tx to enable full information at the RLC Rx. Additionally, how this report can be formatted as well as some behavioral aspects when a redundant report is received are discussed.

The combined approach discussed above works by introducing a new local timer at the RLC Rx. This local timer may be started when a RLC SDU is delivered to higher layers out of sequence, in one example. Upon expiry of this timer, a new report is triggered (which may also be a legacy status report containing dummy ACKs) indicating that PDU as abandoned. The RLC Rx then updates its reception window accordingly. This mechanism is designed to enable the RLC Rx to be in sync with the PDCP reordering window such that the RLC layer is not unnecessarily recovering for packets that may eventually be discarded at the PDCP layer. Additionally, the RLC transmitter stops retransmission or retransmission of PDUs based on the discard indication received from PDCP. And, based on the Rx-based report received from its peer entity, the RLC Tx can update its transmission window to match the reception window at the receiver side. The combined approach discussed above has some drawbacks and gaps that are resolved as follows. The Tx side of RLC has the most accurate information with respect to the discard timer expiry of packets as well as with regards to PDU set information. Without the RLC Rx having such information, the RLC reception window may not be efficiently updated. For example, the new local timer is separately started for every PDU of a PDU set even when pdu-SetDiscard may be configured. The PDCP may submit a PDCP Control PDU to RLC which is treated as a data PDU at the RLC layer. The RLC Rx may abandon a SDU associated with a PDCP Control PDU when the local timer expires.

The techniques discussed herein provide a solution to these drawbacks and gaps that is more favorable in terms of resource utilization as well as latency to make the user plane functionality efficient for services such as XR that are extremely delay-sensitive.

With respect to triggers for Tx-based report, in one or more implementations the RLC Tx triggers a new report (e.g., Tx-based Control PDU) transmitted to its peer entity (e.g., the RLC Rx) that includes some additional information with respect to the invalid (e.g., outdated, expired) packets. Here, invalid (e.g., outdated, expired) packets refer to, e.g., those RLC PDUs associated with PDCP SDUs whose discardTimer or discardTimerForLowImportance has expired. In one example, this trigger is based on a PDU count threshold where if the number of invalid (e.g., outdated, expired) PDUs equals and/or exceeds this count, the RLC Tx triggers this report. This PDU count threshold may, e.g., be configured or pre-configured by the network. In another example, the trigger may be based on a status report received from the RLC receiver (e.g., the Rx-based report triggered upon the expiry of the ‘local timer’). The ‘local timer’ here refers to the new RLC timer on the Rx as discussed above which may be started, e.g., when a RLC SDU is delivered to higher layers out of sequence. Upon expiry of this timer, a new report is triggered (e.g., the Rx-based report which may also be a legacy status report containing dummy ACKs) indicating that PDU as abandoned. The RLC Rx then updates the state variables, timers and its reception window accordingly, and the RLC Tx can trigger this report if the RLC Rx it has some additional information as compared to the information received in the status report, e.g., information of additional invalid (e.g., outdated, expired) packets, or information of a packet indicated as abandoned by the receiver but is not yet invalid (e.g., outdated, expired) on the transmitter. It should be noted that this may involve the RLC transmitter distinguishing between the successfully received (e.g., ACK received) versus the abandoned packets (e.g., a dummy ACK) as described in more detail below.

Furthermore, there may also be one or more additional trigger conditions for the Tx-based report to limit how often the Tx-based report is transmitted. For example, if multiple Tx-based reports are triggered but not transmitted, only one report is transmitted that includes the latest information of invalid (e.g., outdated, expired) (or valid (e.g., non-outdated)) packets. In another example, the Tx-based report is only triggered if one or more packets need to be indicated as invalid (e.g., outdated, expired) (or valid (e.g., non-outdated)) and there exists at least one RLC PDU in the transmission or retransmission buffer.

In one implementation, this report can include information with respect to a number of consecutive invalid (e.g., outdated, expired) PDUs such that the RLC receiver upon reception of such a report may proactively skip starting the ‘local timer’ for the packets indicated as invalid (e.g., outdated, expired). Alternatively, this report may also contain information of the invalid (e.g., outdated, expired) PDUs associated to a PDU set (in the case where pdu-SetDiscard is configured and the discard timer for one or more PDUs of a PDU set expires).

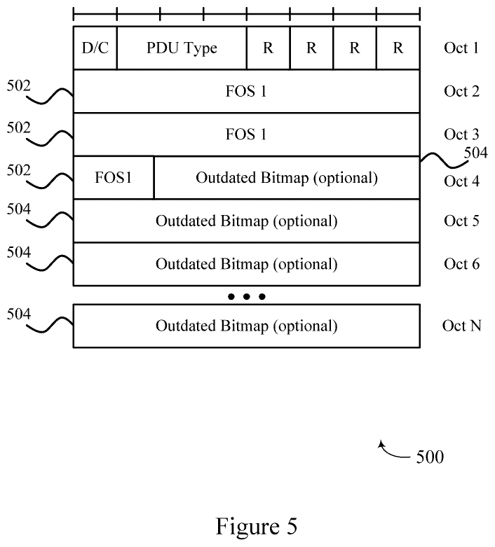

FIG. 5 illustrates an example format 500 for a Tx-based report in accordance with aspects of the present disclosure. The example format 500 is, e.g., for a Tx-based report with 18-bit RLC SN.

In the example format 500, the first outdated SN (FOS), FOS 1 at 502, refers to the smallest RLC SN amongst the SNs of the packet(s) categorized as invalid (e.g., outdated, expired) by the RLC Tx. The outdated bitmap 504 indicates a bitmap for all the following SNs that are invalid (e.g., outdated, expired) such that, e.g., a bit value of ‘0’ indicates a SN as valid (e.g., non-outdated) while bit value of ‘1’ indicates that the SN is invalid (e.g., outdated, expired).

Additionally, or alternatively, the report may include information with respect to those packets which have not been indicated as invalid (e.g., outdated, expired) from PDCP. That is, if the RLC Tx identifies that a RLC PDU is associated with a PDCP SDU whose discard timer is still running, the RLC Tx may indicate this to its peer entity such that the RLC Rx may still receive this packet.

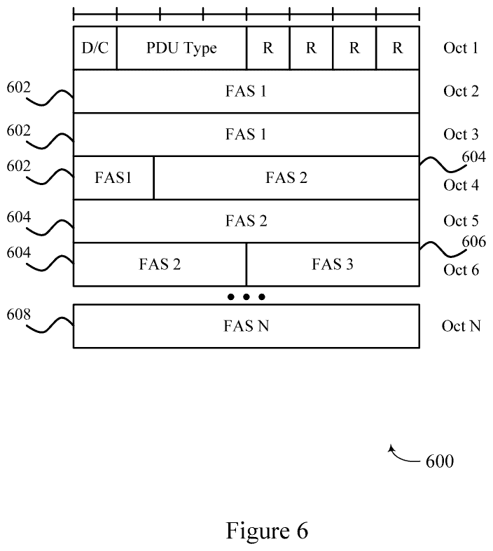

FIG. 6 illustrates an example format 600 for a Tx-based report in accordance with aspects of the present disclosure. The example format 600 is, e.g., for a Tx-based report with 18-bit RLC SN. In the example format 600, the first available SN (FAS), FAS 1 at 602, refers to the smallest RLC SN amongst the SNs categorized as valid (e.g., non-outdated) by the RLC Tx. The remaining FAS, FAS 2 at 604, FAS 3 at 606, through FAS N at 608, refer to the subsequent SNs categorized as valid (e.g., non-outdated) by the RLC Tx.

With respect to RLC Rx-based Report, in one or more implementations the RLC Rx can trigger a new report (e.g., Rx-based Control PDU) upon expiry of the local timer, and this report contains information of the RLC PDUs that are being abandoned by the RLC Rx and this report is transmitted to is peer entity (e.g., the RLC Tx). Here, abandonment refers to those PDUs that the RLC Rx no longer tries to receive if it had not been previously successfully received. In one example, this can be achieved by a separate control PDU (different from the legacy status report) specific to abandoned PDUs. In another example, this report may be a new status report that consists of both RLC PDUs that were successfully received as well as those that are being abandoned with an additional indication to differentiate between the successfully received (e.g., ACK received) versus abandoned PDUs.

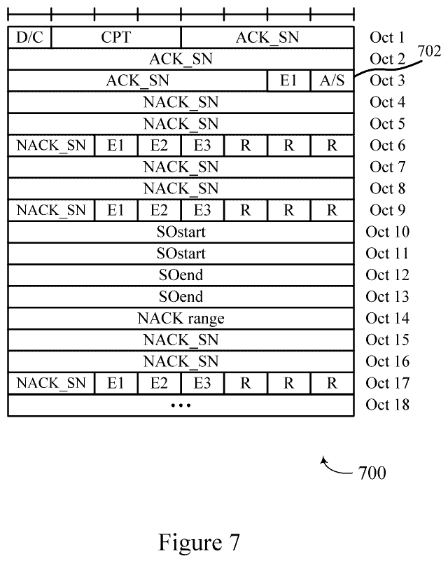

FIG. 7 illustrates an example format 700 for a Rx-based report in accordance with aspects of the present disclosure. The example format 700 is, e.g., for a Rx-based report with 18-bit RLC SN. In the example format 700, the reserved bit 702 may be reused as an indication (abandoned/status (A/S)) of whether the ACK is a dummy ACK representing an abandoned PDU or a real ACK representing the successful reception of the PDU. For example, a bit value ‘0’ may indicate dummy ACK while a bit value ‘1’ indicates a real ACK or vice versa.

Additionally, or alternatively, if the RLC Tx receives a Rx-based report that indicates one or more RLC SNs as abandoned that were not categorized as invalid (e.g., outdated, expired) by the RLC Tx (e.g., the PDCP Tx did not indicate these SDUs as having an expired discard timer), the Tx triggers a Tx-based report as discussed above. In such a case, the RLC Tx may continue to transmit such RLC PDUs even though they were indicated as abandoned. In one example, the RLC Tx transmitter may continue to transmit or retransmit such abandoned but valid (e.g., non-outdated) PDUs regardless of whether they now fall outside the updated transmission window (e.g., the transmission window is updated based at least in part on (e.g., in response to) reception of the last Rx-based report). While on the RLC Rx, when such a Tx-based report is received in response to transmission of a Rx-based report, where one or more previously abandoned PDUs are indicated as valid (e.g., non-outdated), the RLC receiver may continue to deliver to higher layers those abandoned but valid (e.g., non-outdated) RLC PDU(s) regardless of if those PDU(s) now fall outside of the updated reception window (e.g., when such a PDU is received via transmission or retransmission after the reception window is updated in response to transmission of the last Rx-based report). Additionally, or alternatively, when the RLC Tx continues to retransmit or retransmit a RLC PDU that was previously indicated by the Rx side as abandoned but is not categorized as invalid (e.g., outdated, expired), e.g., no discard indication received from the PDCP Tx, there is an additional mechanism to stop the transmission or retransmission. In one example, this may be done based on a threshold condition (e.g., a maximum number of retransmissions after which this packet is discarded at the Tx). In another example, this may be via a status report indicating an ACK where if an ACK is received in response to the transmission or retransmission, the packet is considered as successfully received and may be discarded at the Tx side.

With respect to new RLC PDU for valid (e.g., non-outdated) but abandoned PDUs, in one or more implementations the RLC Tx may instead reconstruct those PDU(s) indicated previously as abandoned but valid (e.g., non-outdated) (e.g., in a Tx-based report in response to a Rx-based report as described above) into new PDU(s) whose SN falls within the updated reception window (the RLC Tx can infer the range of the updated reception window from, e.g., the Rx-based report). Additionally, or alternatively, the newly reconstructed PDU may also fall within the updated transmission window (e.g., the transmission window is updated in response to reception of the last Rx-based report). In one example, this is useful for the recovery of RLC PDUs associated with PDCP Control PDUs. The PDCP Tx does not provide any discard notification for PDCP Control PDUs, hence the RLC PDUs associated with PDCP Control PDUs may not be categorized as invalid (e.g., outdated, expired) even when the RLC Rx indicates them as abandoned. Thus, a Tx-based report to indicate those abandoned PDUs as valid (e.g., non-outdated) would be useful for the RLC Rx to know that such PDUs may still be delivered to higher layers.

Additionally, or alternatively, the RLC Tx upon transmission of the Tx-based report identifies if the initial transmission was not yet started for one or more PDU(s) indicated in the Tx-based report. If one or more PDU(s) indicated in the Tx-based report had not yet been submitted to lower layers for initial transmission, the RLC Tx can reconstruct the abandoned but valid (e.g., non-outdated) PDU(s) into a new PDU with a SN value that falls within the range of the updated reception window (e.g., as indicated in the last received Rx-based report). The original PDU may then be discarded. The reconstructed PDU can also be placed in the transmission or retransmission buffer accordingly.

Additionally, or alternatively, if one or more PDU(s) indicated in the Tx-based report have already been submitted to lower layers, the RLC Tx can reconstruct the abandoned but valid (e.g., non-outdated) PDU(s) into a new one with a SN value that falls within the range of the updated reception window (e.g., as indicated in the last received Rx-based report) and may additionally initialize the RETX_COUNT value for the reconstructed PDUs with a value ‘x’. In one example, x=y+1 where ‘y’ is the RETX_COUNT value of the original PDU that was indicated as abandoned but valid (e.g., non-outdated). This may be done in order to not impact the radio link failure (RLF) procedure. Additionally, or alternatively, the RLC Tx may also initialize the RETX_COUNT value to ‘0’ as per legacy procedure, e.g., x=0.

With respect to behavior when redundant Tx-based report is received, in one or more implementations if a Tx-based report is received by the RLC Rx while the local timer is running, and this Tx-based report indicates the RLC PDU that started the local timer as invalid (e.g., outdated, expired), the local timer may be stopped, and reception window can be updated. The RLC Rx updates the reception window by sliding the reception window (e.g., updating the lower bound of the reception window). For example, the lower bound of the reception window is moved to the next packet that has not been consecutively received (e.g., the RLC Rx moves the lower bound of the reception window as if the RLC PDU that started the local timer had been received by the RLC Rx). This may additionally trigger a Rx-based report in order to update the transmission window. Furthermore, the RLC Rx may also restart the local timer as appropriate (e.g., if the reception window is updated to a next RLC SN that has not yet been received in-order).

Additionally, or alternatively, if a Tx-based report is received and indicates one or more RLC SN(s) that were previously indicated as abandoned by the RLC Rx, as invalid (e.g., outdated, expired)—the RLC Rx may then ignore this Tx-based report. Additionally, if a Rx-based report is received by the RLC Tx indicating one or more RLC SN(s) as abandoned of which one or more RLC SN(s) were previously indicated as invalid (e.g., outdated, expired) by the RLC Tx—the RLC Tx may ignore or skip the Rx-based report accordingly.

Accordingly, the techniques discussed herein describe solutions for synchronizing the information between RLC Tx and Rx (e.g., by means of a Tx-based report that indicates invalid (e.g., outdated, expired) data (or valid (e.g., non-outdated) data)) and the behavior of the respective RLC entities upon reception of such a report. Furthermore, these techniques provide some new RLC receiver behavior where certain data may be received even outside of a reception window. Additionally, these techniques describe some exemplary formats for the new Rx-based and Tx-based reports.

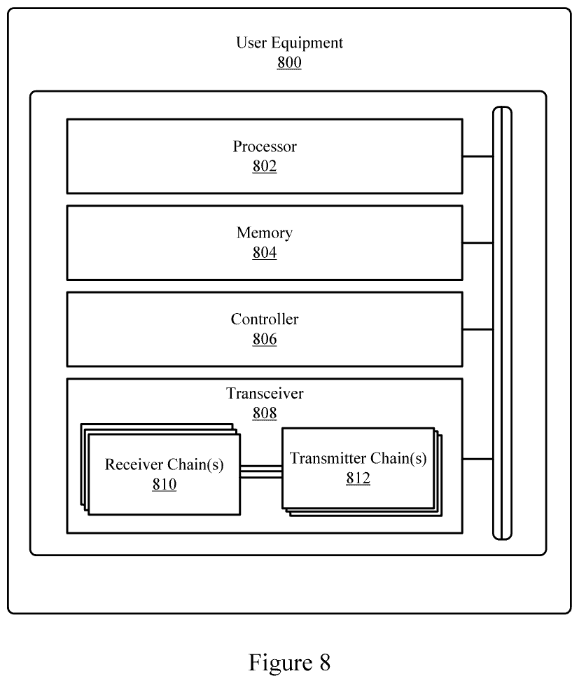

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for transmitting a first signaling that indicates a Tx-based report associated with RLC of the apparatus based at least in part on one or more triggers, one or more conditions, or a combination thereof; receiving a second signaling that indicates a Rx-based report associated with the RLC of the apparatus; and updating, based at least in part on the received Rx-based report, a transmission window of the apparatus.

Additionally, the UE 800 may be configured to support any one or combination of where the Tx-based report includes information that identifies invalid RLC PDUs; where the Tx-based report includes information that identifies valid RLC PDUs; transmitting the first signaling based at least in part on at least a first trigger of the one or more triggers being satisfied, where the first trigger comprises a threshold count value of PDUs; transmitting the first signaling based at least in part on a count value of invalid PDUs being greater than or equal to the threshold count value; transmitting the first signaling based at least in part on a first trigger of the one or more triggers being satisfied, where the first trigger comprises the received Rx-based report, and where the Rx-based report includes information that identifies abandoned data; constructing at least one PDU based at least in part on one or more PDUs previously indicated as one or more of abandoned and valid; and transmitting a third signaling that includes the at least one constructed PDU.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to or operable to support a means for receiving a first signaling that indicates a Tx-based report associated with RLC at the apparatus based at least in part on one or more triggers, one or more conditions, or a combination thereof; transmitting a second signaling that indicates a Rx-based report associated with the RLC of the apparatus; and updating, based at least in part on the transmitted Rx-based report, a reception window of the apparatus.

Additionally, the UE 800 may be configured to support any one or combination of where the Tx-based report includes information that identifies invalid RLC PDUs; where the Tx-based report includes information that identifies invalid RLC PDUs; receiving a third signaling that includes at least one PDU constructed based at least in part on one or more PDUs previously indicated as one or more of abandoned and valid; submitting the at least one PDU to a higher layer of a protocol stack irrespective of whether the at least one PDU is outside of the reception window, where the higher layer is higher than a RLC layer of the protocol stack; receiving an additional Tx-based report that indicates one or more RLC SNs as invalid that were previously indicated as abandoned; and ignoring the additional Tx-based report.

Additionally, or alternatively, the UE 800 may support at least one memory (e.g., the memory 804) and at least one processor (e.g., the processor 802) coupled with the at least one memory and configured to cause the UE to: transmit a first signaling that indicates a Tx-based report associated with RLC of the apparatus based at least in part on one or more triggers, one or more conditions, or a combination thereof; receive a second signaling that indicates a Rx-based report associated with the RLC of the apparatus; and update, based at least in part on the received Rx-based report, a transmission window of the apparatus.

Additionally, the UE 800 may be configured to support any one or combination of where the Tx-based report includes information that identifies invalid RLC PDUs; where the Tx-based report includes information that identifies valid RLC PDUs; where the at least one processor is configured to cause the apparatus to transmit the first signaling based at least in part on at least a first trigger of the one or more triggers being satisfied, where the first trigger comprises a threshold count value of PDUs; where the at least one processor is configured to cause the apparatus to transmit the first signaling based at least in part on a count value of invalid PDUs being greater than or equal to the threshold count value; where the at least one processor is configured to cause the apparatus to: transmit the first signaling based at least in part on a first trigger of the one or more triggers being satisfied, where the first trigger comprises the received Rx-based report, and where the Rx-based report includes information that identifies abandoned data; where the at least one processor is configured to cause the apparatus to: construct at least one PDU based at least in part on one or more PDUs previously indicated as one or more of abandoned and valid; and transmit a third signaling that includes the at least one constructed PDU.

Additionally, or alternatively, the UE 800 may support at least one memory (e.g., the memory 804) and at least one processor (e.g., the processor 802) coupled with the at least one memory and configured to cause the UE to: receive a first signaling that indicates a Tx-based report associated with RLC at the apparatus based at least in part on one or more triggers, one or more conditions, or a combination thereof; transmit a second signaling that indicates a Rx-based report associated with the RLC of the apparatus; and update, based at least in part on the transmitted Rx-based report, a reception window of the apparatus.

Additionally, the UE 800 may be configured to support any one or combination of where the Tx-based report includes information that identifies invalid RLC PDUs; where the Tx-based report includes information that identifies invalid RLC PDUs; where the at least one processor is configured to cause the apparatus to: receive a third signaling that includes at least one PDU constructed based at least in part on one or more PDUs previously indicated as one or more of abandoned and valid; where the at least one processor is configured to cause the apparatus to submit the at least one PDU to a higher layer of a protocol stack irrespective of whether the at least one PDU is outside of the reception window, where the higher layer is higher than a RLC layer of the protocol stack; where the at least one processor is further configured to cause the apparatus to: receive an additional Tx-based report that indicates one or more RLC SNs as invalid that were previously indicated as abandoned; and ignore the additional Tx-based report.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

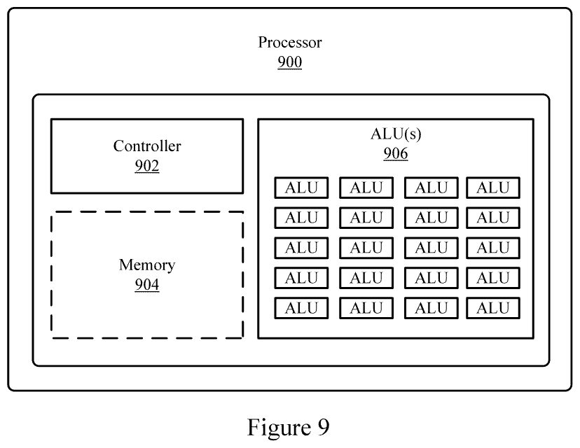

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory addresses of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, ALUs 906, and other functional units of the processor 900.

The memory 904 may include one or more caches (e.g., memory local to or included in the processor 900 or other memory, such as RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, and the controller 902, and may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 may be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to: transmit a first signaling that indicates a Tx-based report associated with RLC of the processor based at least in part on one or more triggers at the processor, one or more conditions at the processor, or a combination thereof; receive a second signaling that indicates a Rx-based report associated with the RLC of the processor; and update, based at least in part on reception of the Rx-based report, a transmission window of the processor.

Additionally, the processor 900 may be configured to or operable to support any one or combination of where the Tx-based report includes information that identifies invalid RLC PDUs or information that identifies invalid RLC PDUs; where the at least one controller is configured to cause the processor to transmit the first signaling based at least in part on at least a first trigger of the one or more triggers being satisfied, where the first trigger comprises a threshold count value of PDUs; where the at least one controller is configured to cause the processor to transmit the first signaling based at least in part on a count value of invalid PDUs being greater than or equal to the threshold count value; where the at least one controller is configured to cause the processor to: transmit the first signaling based at least in part on based at least in part on a first trigger of the one or more triggers being satisfied, where the first trigger comprises the received Rx-based report, and where the Rx-based report includes information that identifies abandoned data; where the at least one controller is configured to cause the processor to: construct at least one PDU based at least in part on one or more PDUs previously indicated as one or more of abandoned and valid; and transmit a third signaling that includes the at least one constructed PDU.

The processor 900 may support wireless communication in accordance with examples as disclosed herein. The processor 900 may be configured to or operable to support at least one controller (e.g., the controller 902) coupled with at least one memory (e.g., the memory 904) and configured to cause the processor to: receive a first signaling that indicates a Tx-based report associated with RLC at the processor based at least in part on one or more triggers, one or more conditions, or a combination thereof; transmit a second signaling that indicates a Rx-based report associated with the RLC of the processor; and update, based at least in part on transmission of the Rx-based report, a reception window of the processor.

Additionally, the processor 900 may be configured to or operable to support any one or combination of where the Tx-based report includes information that identifies invalid RLC PDUs or information that identifies invalid RLC PDUs; where the at least one controller is configured to cause the processor to: receive a third signaling that includes at least one PDU constructed based at least in part on one or more PDUs previously indicated as one or more of abandoned and valid; where the at least one controller is configured to cause the processor to submit the at least one PDU to a higher layer of a protocol stack irrespective of whether the at least one PDU is outside of the reception window, where the higher layer is higher than a RLC layer of the protocol stack; where the at least one controller is further configured to cause the processor to: receive an additional Tx-based report that indicates one or more RLC SNs as invalid that were previously indicated as abandoned; and ignore the additional Tx-based report.

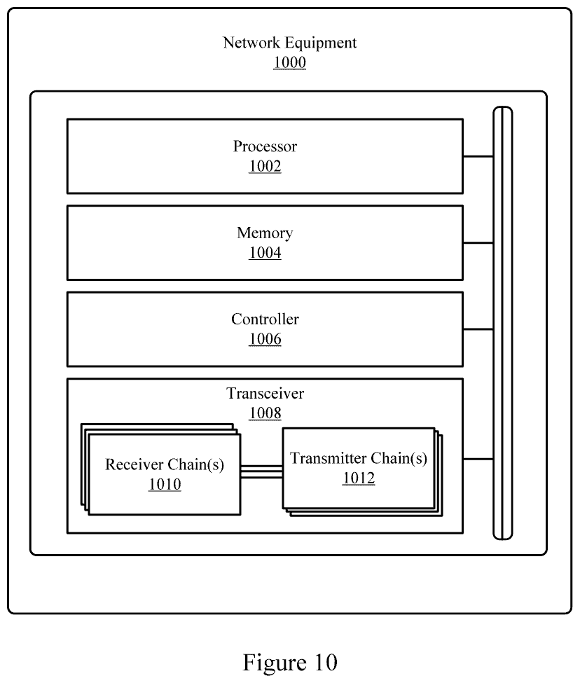

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for transmitting a first signaling that indicates a Tx-based report associated with RLC of the apparatus based at least in part on one or more triggers, one or more conditions, or a combination thereof; receiving a second signaling that indicates a Rx-based report associated with the RLC of the apparatus; and updating, based at least in part on the received Rx-based report, a transmission window of the apparatus.

Additionally, the NE 1000 may be configured to support any one or combination of where the Tx-based report includes information that identifies invalid RLC PDUs; where the Tx-based report includes information that identifies valid RLC PDUs; transmitting the first signaling based at least in part on at least a first trigger of the one or more triggers being satisfied, where the first trigger comprises a threshold count value of PDUs; transmitting the first signaling based at least in part on a count value of invalid PDUs being greater than or equal to the threshold count value; transmitting the first signaling based at least in part on a first trigger of the one or more triggers being satisfied, where the first trigger comprises the received Rx-based report, and where the Rx-based report includes information that identifies abandoned data; constructing at least one PDU based at least in part on one or more PDUs previously indicated as one or more of abandoned and valid; and transmitting a third signaling that includes the at least one constructed PDU.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for receiving a first signaling that indicates a Tx-based report associated with RLC at the apparatus based at least in part on one or more triggers, one or more conditions, or a combination thereof; transmitting a second signaling that indicates a Rx-based report associated with the RLC of the apparatus; and updating, based at least in part on the transmitted Rx-based report, a reception window of the apparatus.

Additionally, the NE 1000 may be configured to support any one or combination of where the Tx-based report includes information that identifies invalid RLC PDUs; where the Tx-based report includes information that identifies invalid RLC PDUs; receiving a third signaling that includes at least one PDU constructed based at least in part on one or more PDUs previously indicated as one or more of abandoned and valid; submitting the at least one PDU to a higher layer of a protocol stack irrespective of whether the at least one PDU is outside of the reception window, where the higher layer is higher than a RLC layer of the protocol stack; receiving an additional Tx-based report that indicates one or more RLC SNs as invalid that were previously indicated as abandoned; and ignoring the additional Tx-based report.

Additionally, or alternatively, the NE 1000 may support at least one memory (e.g., the memory 1004) and at least one processor (e.g., the processor 1002) coupled with the at least one memory and configured to cause the NE to: transmit a first signaling that indicates a Tx-based report associated with RLC of the apparatus based at least in part on one or more triggers, one or more conditions, or a combination thereof; receive a second signaling that indicates a Rx-based report associated with the RLC of the apparatus; and update, based at least in part on the received Rx-based report, a transmission window of the apparatus.

Additionally, the NE 1000 may be configured to support any one or combination of where the Tx-based report includes information that identifies invalid RLC PDUs; where the Tx-based report includes information that identifies valid RLC PDUs; where the at least one processor is configured to cause the apparatus to transmit the first signaling based at least in part on at least a first trigger of the one or more triggers being satisfied, where the first trigger comprises a threshold count value of PDUs; where the at least one processor is configured to cause the apparatus to transmit the first signaling based at least in part on a count value of invalid PDUs being greater than or equal to the threshold count value; where the at least one processor is configured to cause the apparatus to: transmit the first signaling based at least in part on a first trigger of the one or more triggers being satisfied, where the first trigger comprises the received Rx-based report, and where the Rx-based report includes information that identifies abandoned data; where the at least one processor is configured to cause the apparatus to: construct at least one PDU based at least in part on one or more PDUs previously indicated as one or more of abandoned and valid; and transmit a third signaling that includes the at least one constructed PDU.

Additionally, or alternatively, the NE 1000 may support at least one memory (e.g., the memory 1004) and at least one processor (e.g., the processor 1002) coupled with the at least one memory and configured to cause the NE to: receive a first signaling that indicates a Tx-based report associated with RLC at the apparatus based at least in part on one or more triggers, one or more conditions, or a combination thereof; transmit a second signaling that indicates a Rx-based report associated with the RLC of the apparatus; and update, based at least in part on the transmitted Rx-based report, a reception window of the apparatus.

Additionally, the NE 1000 may be configured to support any one or combination of where the Tx-based report includes information that identifies invalid RLC PDUs; where the Tx-based report includes information that identifies invalid RLC PDUs; where the at least one processor is configured to cause the apparatus to: receive a third signaling that includes at least one PDU constructed based at least in part on one or more PDUs previously indicated as one or more of abandoned and valid; where the at least one processor is configured to cause the apparatus to submit the at least one PDU to a higher layer of a protocol stack irrespective of whether the at least one PDU is outside of the reception window, where the higher layer is higher than a RLC layer of the protocol stack; where the at least one processor is further configured to cause the apparatus to: receive an additional Tx-based report that indicates one or more RLC SNs as invalid that were previously indicated as abandoned; and ignore the additional Tx-based report.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

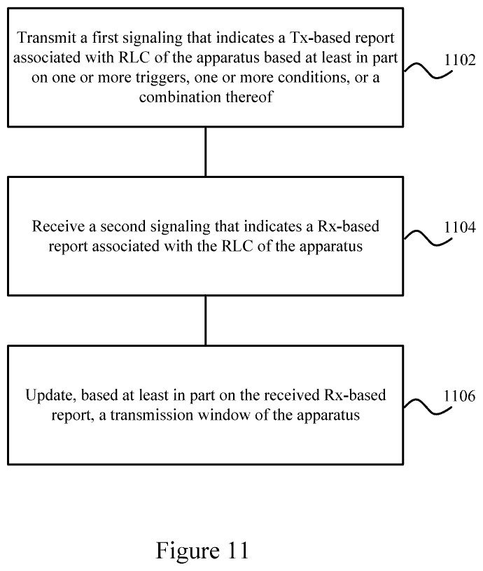

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 1102, the method may include transmitting a first signaling that indicates a Tx-based report associated with RLC of the apparatus based at least in part on one or more triggers, one or more conditions, or a combination thereof. The operations of 1102 may be performed in accordance with examples as described herein. In some implementations, aspects of the operations of 1102 may be performed by a UE as described with reference to FIG. 8. In some implementations, aspects of the operations of 1102 may be performed by a NE as described with reference to FIG. 10.

At 1104, the method may include receiving a second signaling that indicates a Rx-based report associated with the RLC of the apparatus. The operations of 1104 may be performed in accordance with examples as described herein. In some implementations, aspects of the operations of 1104 may be performed by a UE as described with reference to FIG. 8. In some implementations, aspects of the operations of 1104 may be performed by a NE as described with reference to FIG. 10.

At 1106, the method may include updating, based at least in part on the received Rx-based report, a transmission window of the apparatus. The operations of 1106 may be performed in accordance with examples as described herein. In some implementations, aspects of the operations of 1106 may be performed a UE as described with reference to FIG. 8. In some implementations, aspects of the operations of 1106 may be performed by a NE as described with reference to FIG. 10.

It should be noted that the method described herein describes a possible implementation, and that the operations and the steps may be rearranged or otherwise modified and that other implementations are possible.

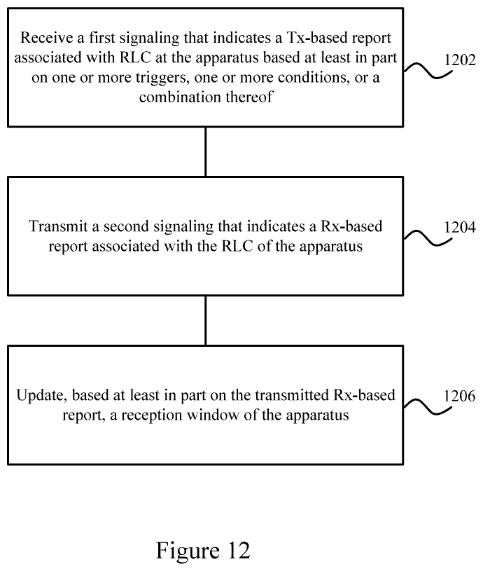

FIG. 12 illustrates a flowchart of a method in accordance with aspects of the present disclosure. The operations of the method may be implemented by a UE as described herein. In some implementations, the UE may execute a set of instructions to control the function elements of the UE to perform the described functions. Additionally, or alternatively, the operations of the method may be implemented by a NE as described herein. In some implementations, the NE may execute a set of instructions to control the function elements of the NE to perform the described functions.

At 1202, the method may include receiving a first signaling that indicates a Tx-based report associated with RLC at the apparatus based at least in part on one or more triggers, one or more conditions, or a combination thereof. The operations of 1202 may be performed in accordance with examples as described herein. In some implementations, aspects of the operations of 1202 may be performed by a UE as described with reference to FIG. 8. In some implementations, aspects of the operations of 1202 may be performed by a NE as described with reference to FIG. 10.

At 1204, the method may include transmitting a second signaling that indicates a Rx-based report associated with the RLC of the apparatus. The operations of 1204 may be performed in accordance with examples as described herein. In some implementations, aspects of the operations of 1204 may be performed by a UE as described with reference to FIG. 8. In some implementations, aspects of the operations of 1204 may be performed by a NE as described with reference to FIG. 10.

At 1206, the method may include updating, based at least in part on the transmitted Rx-based report, a reception window of the apparatus. The operations of 1206 may be performed in accordance with examples as described herein. In some implementations, aspects of the operations of 1206 may be performed a UE as described with reference to FIG. 8. In some implementations, aspects of the operations of 1206 may be performed by a NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and configured to cause the apparatus to:
transmit a first signaling that indicates a transmitter-based (Tx-based) report associated with radio link control (RLC) of the apparatus based at least in part on one or more triggers, one or more conditions, or a combination thereof;
receive a second signaling that indicates a receiver-based (Rx-based) report associated with the RLC of the apparatus; and
update, based at least in part on the received Rx-based report, a transmission window of the apparatus.

2. The apparatus of claim 1, wherein the Tx-based report includes information that identifies invalid RLC packet data units (PDUs).

3. The apparatus of claim 1, wherein the Tx-based report includes information that identifies valid RLC packet data units (PDUs).

4. The apparatus of claim 1, wherein the at least one processor is configured to cause the apparatus to transmit the first signaling based at least in part on at least a first trigger of the one or more triggers being satisfied, wherein the first trigger comprises a threshold count value of packet data units (PDUs).

5. The apparatus of claim 4, wherein the at least one processor is configured to cause the apparatus to transmit the first signaling based at least in part on a count value of invalid PDUs being greater than or equal to the threshold count value.

6. The apparatus of claim 1, wherein the at least one processor is configured to cause the apparatus to:
transmit the first signaling based at least in part on a first trigger of the one or more triggers being satisfied,
wherein the first trigger comprises the received Rx-based report, and
wherein the Rx-based report includes information that identifies abandoned data.

7. The apparatus of claim 1, wherein the at least one processor is configured to cause the apparatus to:
construct at least one packet data unit (PDU) based at least in part on one or more packet data units (PDUs) previously indicated as one or more of abandoned and valid; and
transmit a third signaling that includes the at least one constructed PDU.

8. An apparatus for wireless communication, comprising:
at least one memory; and
at least one processor coupled with the at least one memory and configured to cause the apparatus to:
receive a first signaling that indicates a transmitter-based (Tx-based) report associated with radio link control (RLC) at the apparatus based at least in part on one or more triggers, one or more conditions, or a combination thereof;
transmit a second signaling that indicates a receiver-based (Rx-based) report associated with the RLC of the apparatus; and
update, based at least in part on the transmitted Rx-based report, a reception window of the apparatus.

9. The apparatus of claim 8, wherein the Tx-based report includes information that identifies invalid RLC packet data units (PDUs).

10. The apparatus of claim 8, wherein the Tx-based report includes information that identifies invalid RLC packet data units (PDUs).

11. The apparatus of claim 8, wherein the at least one processor is configured to cause the apparatus to:
receive a third signaling that includes at least one packet data unit (PDU) constructed based at least in part on one or more PDUs previously indicated as one or more of abandoned and valid.

12. The apparatus of claim 11, wherein the at least one processor is configured to cause the apparatus to submit the at least one PDU to a higher layer of a protocol stack irrespective of whether the at least one PDU is outside of the reception window, wherein the higher layer is higher than a RLC layer of the protocol stack.

13. The apparatus of claim 8, wherein the at least one processor is further configured to cause the apparatus to:
receive an additional Tx-based report that indicates one or more RLC sequence numbers (SNs) as invalid that were previously indicated as abandoned; and
ignore the additional Tx-based report.

14. A processor for wireless communication, comprising:
at least one controller coupled with at least one memory and configured to cause the processor to:
transmit a first signaling that indicates a transmitter-based (Tx-based) report associated with radio link control (RLC) of the processor based at least in part on one or more triggers at the processor, one or more conditions at the processor, or a combination thereof;
receive a second signaling that indicates a receiver-based (Rx-based) report associated with the RLC of the processor; and
update, based at least in part on reception of the Rx-based report, a transmission window of the processor.

15. The processor of claim 14, wherein the Tx-based report includes information that identifies invalid RLC packet data units (PDUs) or information that identifies invalid RLC PDUs.

16. The processor of claim 14, wherein the at least one controller is configured to cause the processor to transmit the first signaling based at least in part on at least a first trigger of the one or more triggers being satisfied, wherein the first trigger comprises a threshold count value of packet data units (PDUs).

17. The processor of claim 16, wherein the at least one controller is configured to cause the processor to transmit the first signaling based at least in part a count value of invalid PDUs being greater than or equal to the threshold count value.

18. A processor for wireless communication, comprising:
at least one controller coupled with at least one memory and configured to cause the processor to:
receive a first signaling that indicates a transmitter-based (Tx-based) report associated with radio link control (RLC) at the processor based at least in part on one or more triggers, one or more conditions, or a combination thereof;
transmit a second signaling that indicates a receiver-based (Rx-based) report associated with the RLC of the processor; and
update, based at least in part on transmission of the Rx-based report, a reception window of the processor.

19. The processor of claim 18, wherein the Tx-based report includes information that identifies invalid RLC packet data units (PDUs) or information that identifies invalid RLC PDUs.

20. The processor of claim 18, wherein the at least one controller is configured to cause the processor to:
receive a third signaling that includes at least one additional packet data unit (PDU) constructed based at least in part on one or more PDUs previously indicated as one or more of abandoned and valid; and
submit the at least one PDU to a higher layer of a protocol stack irrespective of whether the at least one PDU is outside of the reception window, wherein the higher layer is higher than a RLC layer of the protocol stack.
